(19) United States
(12) Patent Application Publication
(10) Pub. No.: US 2017/0265222 A1
(43) Pub. Date: Sep. 14, 2017

(54) RADIO RECEPTION DEVICE, RADIO TRANSMISSION DEVICE, COMMUNICATION SYSTEM, AND COMMUNICATION METHOD

(71) Applicant: Sharp Kabushiki Kaisha, Sakai City, Osaka (JP)

(72) Inventors: Hiromichi TOMEBA, Sakai City (JP); Tomoki YOSHIMURA, Sakai City (JP); Takashi ONODERA, Sakai City (JP)

(21) Appl. No.: 15/505,988

(22) PCT Filed: Aug. 28, 2015
(86) PCT No.: PCT/JP2015/074395

§ 371 Date: Feb. 23, 2017

(30) Foreign Application Priority Data
Sep. 12, 2014 (JP) 2014-185781

(51) Int. Cl. H04W 74/08; H04L 5/00; H04W 72/04

(52) U.S. Cl. CPC H04W 74/085; H04W 72/0446; H04L 5/0048; H04W 84/12

(57) ABSTRACT

Communication opportunities of existing terminal devices are ensured, in a communication system in which with CSMA/CA as a premise, terminal devices capable of using a new CCA level and the existing terminal devices using an existing CCA level coexist. A communication method of a radio reception device of the present invention includes receiving a signal of information on a CCA level used for carrier sense from a radio transmission device, determining the CCA level used for the carrier sense based on the signal, and performing the carrier sense, based on the CCA level.

### TECHNICAL FIELD

The present invention relates to a radio reception device, a radio transmission device, a communication system, and a communication method.

### BACKGROUND ART

As a development standard of IEEE 802.11n which is a widely practiced wireless local area network (LAN) standard, IEEE 802.11ac standard was defined by the institute of electrical and electronics engineers, Inc. (IEEE). Currently, standardization activities of IEEE 802.11 ax have been started as a successor standard to IEEE 802.11 n/ac. In the current wireless LAN system, interference due to an increase in the number of terminals per area is becoming a big problem, and it is necessary to consider such overcrowded environment in the IEEE 802.11ax standard. On the other hand, in the IEEE 802.11ax standard, not only improvement in peak throughput but also improvement in user throughput are main requirements, unlike the past wireless LAN standard. It is indispensable to introduce a highly efficient simultaneous multiplexing transmission method (access method) in order to improve the user throughput.

In the standards up to IEEE 802.11n, an access method of autonomous distributed control method called carrier sense multiple access with collision avoidance (CSMA/CA) has been adopted as an access method. In the IEEE 802.11ac, a space division multiple access (SDMA) with a multi-user multiple-input multiple-output (MU-MIMO) technology was newly added.

In the IEEE 802.11ax standard, backward compatibility for the existing IEEE 802.11 standard is required. This suggests that it is necessary to support the access method based on CSMA/CA even in the IEEE 802.11ax standard. However, in CSMA/CA which requires carrier sense prior to transmission, there is a problem that communication opportunities are greatly reduced due to interference between terminal devices under the overcrowded environment as described above. Therefore, recently, changing the threshold (CCA level) of clear channel assessment (CCA) by carrier sense has been discussed for the purpose of allowing some interference and improving communication opportunities (see NPL 1 or the like). Since the terminal device stops communication when the interference of the CCA level or more is measured by carrier sense, the possibility of the terminal device losing the communication opportunity becomes low even in overcrowded environment, by increasing the CCA level. As a matter of course, increasing the CCA level causes degradation of reception quality due to interference, but communication quality is expected to be maintained by a packet capture effect peculiar to packet transmission and adaptive modulation transmission.

### CITATION LIST

### Non Patent Literature

NPL 1: IEEE 11-14/0628r0, “Measurements on CCA thresholds in OBSS environment,” May 2014.

### SUMMARY OF INVENTION

### Technical Problem

However, there is a problem that a new terminal device compliant with the IEEE 802.11ax standard performs transmission based on a newly defined CCA level and obtains many communication opportunities, whereas existing terminal devices that perform communication based on the existing CCA level (a terminal device which exists already, a legacy terminal device) can hardly obtain communication opportunities.

The present invention has been made in view of the above problems, and an object thereof is to provide a radio transmission device, a radio reception device, a communication system, and a communication method, which are capable of improving communication opportunities of new terminal devices while securing communication opportunities of existing terminal devices, in a communication system in which with CSMA/CA as a premise, terminal devices capable of using a new CCA level and existing terminal devices using an existing CCA level coexist.

### Solution to Problem

A radio transmission device, a radio reception device, a communication system, and a communication method according to the present invention for solving the above problems are as follows.

(1) In other words, a radio reception device of the present invention is a radio reception device which performs communication with a radio transmission device, in a communication system requiring carrier sense, includes a wireless reception unit that performs the carrier sense, receives a signal of information on a CCA level used for the carrier sense from the radio transmission device, and determines the CCA level used for the carrier sense based on

(2) In the radio reception device according to (1), the wireless reception unit changes the CCA level, based on a type of a received signal.

(3) The radio reception device according to (1) or (2) further includes a wireless transmission unit that transmits a signal addressed to the radio transmission device, the wireless transmission unit starts transmission of the signal after a transmission standby time, and the transmission standby time is determined based on the CCA level.

(4) In the radio reception device according to (3), the wireless transmission unit has a plurality of frame transmission standby times, at least one of the plurality of frame transmission standby times is determined based on the CCA level, and the frame transmission standby times are included in the transmission standby time.

(5) In the radio reception device according to (4), the wireless transmission unit switches the frame transmission standby times, depending on the CCA level used by the wireless reception unit for the carrier sense.

(6) In the radio reception device according to (3), the wireless transmission unit has a function of determining a random backoff time, the random backoff time is determined based on the CCA level, and the random backoff time is included in the transmission standby time.

(7) In the radio reception device according to (3), the wireless transmission unit determines the transmission standby time, based on a type of a signal addressed to the radio transmission device.

(8) A radio transmission device of the present invention is a radio transmission device which performs communication with a radio reception device, in a communication system requiring carrier sense, includes a wireless transmission unit that transmits a signal addressed to the radio reception device, and signals information on a CCA level used for the carrier sense to the radio reception device.

(9) In the radio transmission device according to (8), the information on the CCA level is a difference from a legacy CCA level.

(10) In the radio transmission device according to (8) or (9), the wireless transmission unit has a function of broadcasting a signal, and the information on the CCA level is included in either the signal broadcasted by the wireless transmission unit or a control signal of the signal transmitted to the radio transmission device by the wireless transmission unit.

(11) A communication system of the present invention is a communication system including a radio transmission device and a radio reception device, and requiring carrier sense, the radio transmission device includes a wireless transmission unit that transmits a signal addressed to the radio reception device, signals information on a CCA level used for the carrier sense to the radio reception device, and the radio reception device includes a wireless reception unit that performs the carrier sense, receives a signal of information on a CCA level used for the carrier sense from the radio transmission device, and determines the CCA level used for the carrier sense based on the signal.

(12) A communication method of a radio reception device which performs communication with a radio transmission device, in a communication system requiring carrier sense, includes a step of receiving a signal of information on a CCA level used for the carrier sense from the radio transmission device, a step of determining the CCA level used for the carrier sense, based on the signal, and a step of performing the carrier sense, based on the CCA level.

(13) A communication method of a radio transmission device which performs communication with a radio reception device, in a communication system requiring carrier sense, includes a step of signaling information on a CCA level used for the carrier sense to the radio reception device.

### Advantageous Effects of Invention

According to the present invention, it is possible to realize a wireless LAN system capable of improving communication opportunities of new terminal devices while securing communication opportunities of existing terminal devices, so it is possible to greatly improve user throughput.

### BRIEF DESCRIPTION OF DRAWINGS

FIG. 1 is a diagram illustrating an example of a communication system according to the present invention.

FIG. 2 is a diagram illustrating an example of communication according to the present invention.

FIG. 3 is a schematic block diagram illustrating a configuration example of a radio transmission device according to the present invention.

FIG. 4 is a diagram illustrating an example of a frame configuration of a signal of the present invention.

FIG. 5 is a diagram illustrating a configuration example of a signal of the present invention.

FIG. 6 is a schematic block diagram illustrating a configuration example of a radio reception device according to the present invention.

FIG. 7 is a diagram illustrating an example of communication according to the present invention.

FIG. 8 is a diagram illustrating an example of communication according to the present invention.

### DESCRIPTION OF EMBODIMENTS

### 1. First Embodiment

A communication system according to the present embodiment includes a radio transmission device (access point (AP)), and a plurality of radio reception devices (stations (STA)).

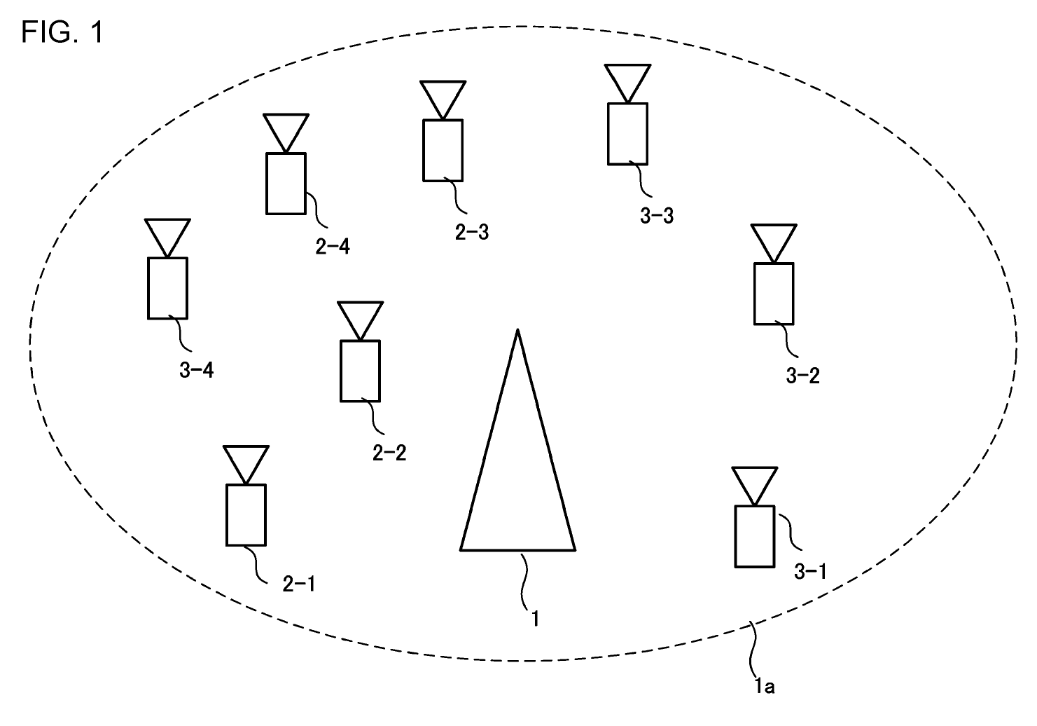

FIG. 1 is a schematic diagram illustrating an example of a downlink of a communication system according to a first embodiment of the present invention. In the communication system of FIG. 1, there is an AP 1, and 1a indicates a range (coverage range, basic service set (BSS)) that can be managed by the AP1. There are STAs 2-1 to 4 connected to the AP 1 and STAs 3-1 to 4 that are existing terminal devices (terminal devices which exist already, legacy terminal devices) in the BSS 1a. Hereinafter, STAs 3-1 to 4 are simply referred to as an STA 3. Similarly, STAs 3-1 to 4 are also simply referred to as an STA 3. The AP1, the STA 2, and the STA 3 have different standards that can respectively be handled. For example, the AP 1 and the STA 2 are devices to which the present invention can be applied, and the STA 3 is a device to which the present invention is not applied.

It is assumed that the AP 1, the STA 2, and the STA 3 communicate with each other based on carrier sense multiple access with collision avoidance (CSMA/CA). In the present embodiment, an infrastructure mode is targeted in which the STA 2 and the STA 3 respectively communicate with the AP 1, but the method of the present embodiment can be implemented even in an ad-hoc mode in which the STAs directly communicate with each other.

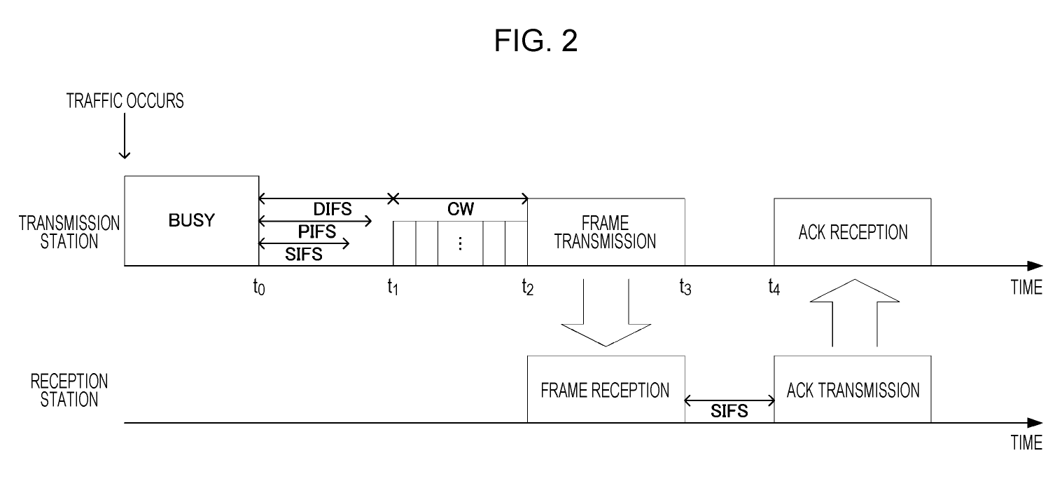

FIG. 2 is a schematic diagram illustrating an example of communication in an IEEE 802.11 system performing communication based on CSMA/CA. Here, an example is illustrated in which a transmission frame is transmitted to a certain reception station from a certain transmission station. First, when traffic data addressed to the reception station is generated at the transmission station, the transmission station performs carrier sense for determining whether or not a communication medium (for example, a frequency band) used for transmitting the traffic data can be ensured. In the example of FIG. 2, at time t₀, the transmission station determines that the communication medium can be ensured. Thereafter, the transmission station waits only for a frame transmission standby time (Inter frame space: IFS) which is set according to the priority of a frame to be transmitted. The IFS includes short IFS (SIFS) used for transmission of a frame with a highest priority, Distributed IFS (DIFS) used for transmission of a normal transmission frame, or the like. By setting different frame transmission standby time according to the priority, the communication opportunity of the transmission frame with a high priority can be prevented from being interfered by other transmission frames.

In the example of FIG. 2, after waiting only for DIFS, the transmission station next waits for a random backoff time to prevent frame collision, and then transmits a transmission frame. In the IEEE 802.11 system, a random backoff time called Contention window (CW) is used. In CSMA/CA, it is assumed that a transmission frame transmitted by a certain transmission station is received by a reception station in a state where there is no interference from the other transmission stations. Therefore, if the transmission stations transmit transmission frames at the same timing, the frames collide with each other, and the reception stations cannot correctly receive the frames. Hence, since each transmission station waits for a time set randomly before starting transmission, frame collision is avoided.

After receiving the frame, the reception station transmits a reception completion notice (Acknowledge: ACK) signal indicating that the frame is received correctly, to the transmission station. The ACK signal is one of transmission frames with a high priority transmitted only by waiting for the SIFS period. Upon receiving the ACK signal from the reception station, the transmission station terminates a series of communication. If the reception station cannot correctly receive the frame transmitted from the transmission station, the reception station does not transmit the ACK. Therefore, if the transmission station does not receive the ACK signal from the reception station for a certain period (SIFS+ACK signal length) after the frame transmission, the transmission station determines that the communication has failed and terminates the communication. The AP 1, the STA 2, and the STA 3 included in the communication system according to the present embodiment have a function of performing communication based on CSMA/CA as illustrated in FIG. 2.

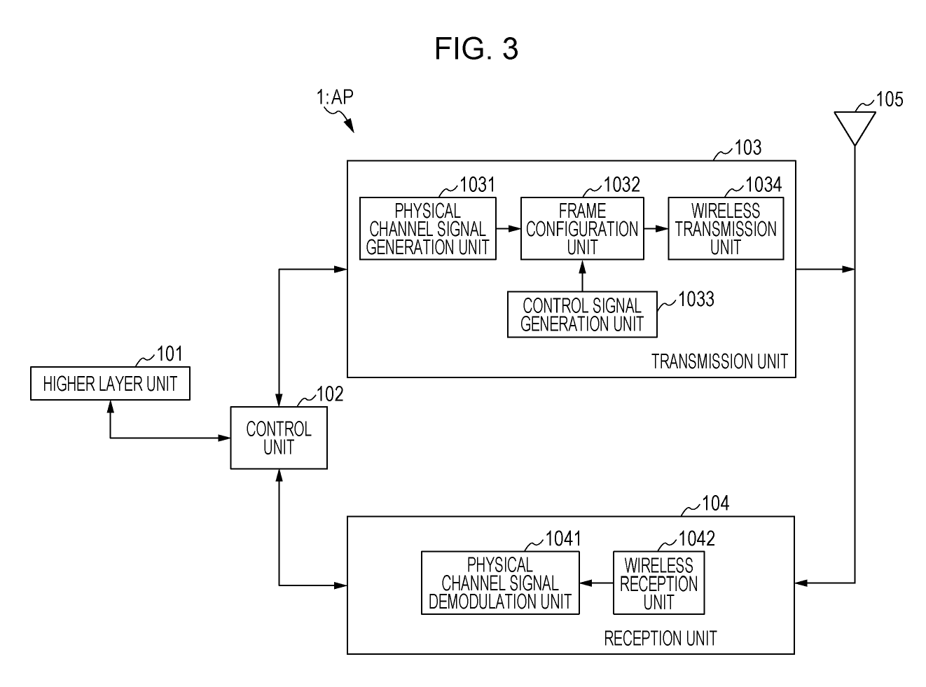

FIG. 3 is a block diagram illustrating an example of the configuration of the AP 1 according to the first embodiment of the present invention. As illustrated in FIG. 3, the AP 1 includes a higher layer unit 101, a control unit 102, a transmission unit 103, a reception unit 104, and an antenna 105.

The higher layer unit 101 performs processes of a medium access control (MAC) layer or the like. In addition, the higher layer unit 101 generates information for controlling the transmission unit 103 and the reception unit 104, and outputs the information to the control unit 102. The control unit 102 controls the higher layer unit 101, the transmission unit 103, and the reception unit 104.

The transmission unit 103 further includes a physical channel signal generation unit 1031, a frame configuration unit 1032, a control signal generation unit 1033, and a wireless transmission unit 1034. The physical channel signal generation unit 1031 generates a baseband signal that the AP 1 transmits to each STA. The signal generated by the physical channel signal generation unit 1031 includes Training field (TF) that each STA uses for channel estimation and data transmitted by a MAC service data unit (MSDU). Since the number of STAs is set to 8 in FIG. 1, an example of generating the baseband signals to be transmitted to the STAs 2-1 to 4 and the STAs 3-1 to 4 is illustrated, but the present embodiment is not limited to this.

The frame configuration unit 1032 multiplexes the signal generated by the physical channel signal generation unit 1031 and the signal generated by the control signal generation unit 1033, and constitutes a transmission frame of the baseband signal actually transmitted by the AP 1.

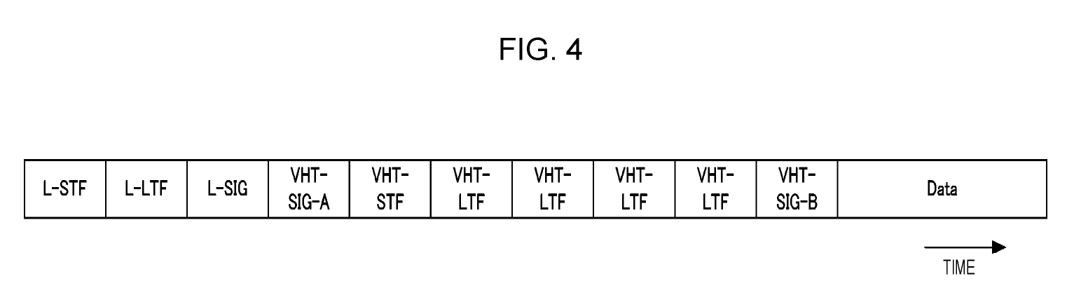

FIG. 4 is a schematic diagram illustrating an example of a transmission frame generated by the frame configuration unit 1032 according to the present embodiment. The transmission frame includes reference signals such as a Legacy short training filed (L-STF), a Legacy long training filed (L-LTF), a Very high throughput-short training field (VHT-STF), and a Very high throughput-long training field (VHT-LTF). The transmission frame includes control information such as Legacy-signal (L-SIG), Very High throughput-signal-A (VHT-SIG-A), and Very high throughput-signal-B (VHT-SIG-B). Further, the transmission frame includes a Data (data) portion. The configuration of the transmission frame generated by the frame configuration unit 1032 is not limited to that illustrated in FIG. 4, and may include other pieces of control information (for example, high throughput signal (HT-SIG)), a reference signal (for example, high throughput LTF (HT-LTF)), or the like. Further, the transmission frame generated by the frame configuration unit 1032 does not need to include all signals such as L-STF and VHT-SIG-A. Since the control information included in the L-SIG or the like is information required for demodulating the Data portion, the control information included in the L-SIG or the like is also described below as the physical layer header (PHY header).

The transmission frames generated by the frame configuration unit 1032 are classified into several frame types. For example, the frame configuration unit 1032 can generate transmission frames of three frame types which are a management frame for managing a connection state between devices, a control frame for managing a communication state between devices, and a data frame including actual transmission data. The frame configuration unit 1032 can include information indicating the frame type to which the transmission frame to be generated belongs, in the medium access control layer header (MAC header) that is transmitted in the Data portion.

As a management frame, the AP 1 can periodically broadcast a beacon frame indicating the identification number or the like of the AP 1 to the BSS, as a management frame. Each STA can grasp the existence of the AP 1 by receiving the beacon frame.

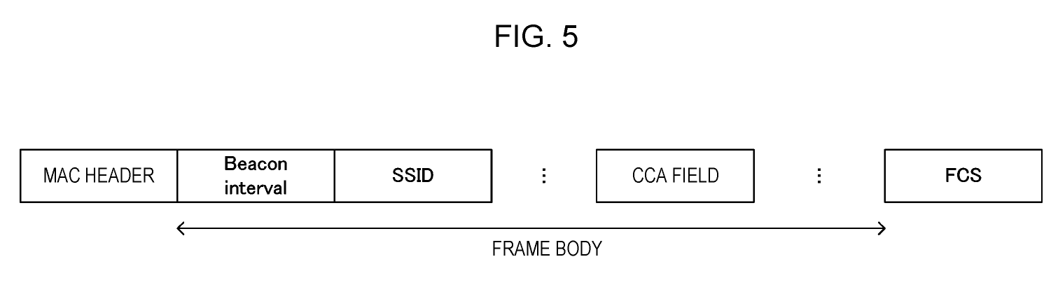

FIG. 5 is a diagram illustrating an example of information included in a beacon frame generated by the AP 1 according to the present embodiment. The beacon frame includes a MAC header including a frame type, a source address, and the like, a frame body including actual data, a frame check sequence (FCS) for checking whether there is an error in the frame. The frame body of the beacon frame generated by the AP 1 according to the present embodiment includes a field (Field) describing an interval (Beacon interval) in which a beacon is transmitted and information for identifying the AP 1 (Service set identifier (SSID) or the like), the beacon also including an existing beacon frame (legacy beacon frame) that can be received also by the STA 3 which is the legacy terminal. The frame body of the beacon frame generated by the AP 1 according to the present embodiment further includes a field (CCA field) describing information on a clear channel assessment (CCA) used when the STA 2 performs carrier sense.

The AP 1 according to the present embodiment is capable of instructing the STA 2 to perform carrier sense at a CCA level different from that of the STA 3 that is a legacy terminal device. For example, the AP 1 can directly describe the CCA level value in the CCA field of the beacon frame. The STA 2 can recognize the CCA level usable by the STA 2 in the BSS managed by the AP 1 that transmitted the beacon frame, by receiving the beacon frame and reading the CCA level described in the CCA field. On the other hand, since the STA 3 which is the legacy terminal device cannot read the CCA field, communication is performed based on the existing CCA level. Hereinafter, the CCA level used by the STA 3 is described as the legacy CCA level. Unless otherwise specified, in the case of simply describing the CCA level or describing the variable CCA level, it refers to the CCA level that can be used by the STA 2 or the AP 1 to which the present invention is applied. The CCA level that can be used only by the STA 2 is also described as a first CCA level, and the legacy CCA level is described as a second CCA level.

The AP 1 can also describe a difference (CCA offset) between the legacy CCA level and the variable CCA level in the CCA field.

In addition, the STA 2 previously recognizes at least one CCA level different from the legacy CCA level as the variable CCA level, and the AP 1 can signal to the STA 2 that the variable CCA level different from the legacy CCA level is used, in the beacon frame. In this case, one-bit information indicating whether or not the variable CCA level is used is described in the CCA field.

The AP 1 can signal the above information in a management frame other than the beacon frame. Further, instead of signaling the information on the CCA level in the transmission frame of a specific type, the AP 1 can include the information (for example, CCA level or CCA offset), for example, in the PHY header of a transmission frame.

The AP 1 does not necessarily signal a usage instruction of a CCA level different from the legacy CCA level, to the STA 2. For example, when most of the devices connected to the AP 1 are the STAs 2, or most of the types (kinds) of the signals transmitted by the AP 1 are signals addressed to the STA 2 to which the present invention is applied, or when most of the types of the signals received by the AP 1 are signals received from the STA 2 to which the present invention is applied, the AP 1 may signal the legacy CCA level to the STA 2, or stop the notification of the CCA level itself.

The wireless transmission unit 1034 performs a process of converting the baseband signal generated by the frame configuration unit 1032 into a signal in a radio frequency (RF) band. The process performed by the wireless transmission unit 1034 includes digital-analog conversion, filtering, frequency conversion from a baseband to an RF band, and the like.

The antenna 105 transmits the signal generated by the transmission unit 103 to each STA.

The AP 1 also has a function of receiving a signal transmitted from each STA. The antenna 105 receives the signal transmitted from each STA and outputs it to the reception unit 104.

The reception unit 104 includes a physical channel signal demodulation unit 1041, and a wireless reception unit 1042. The wireless reception unit 1042 converts the RF band signal input from the antenna 105 into a baseband signal. The process performed by the wireless reception unit 1042 includes frequency conversion from the RF band to the baseband band, filtering, analog/digital conversion, and the like. In addition, the process performed by the reception unit 104 may include a function of measuring ambient interference in a specific frequency band and securing the frequency band (carrier sense).

The physical channel signal demodulation unit 1041 demodulates the baseband signal output from the wireless reception unit 1042. The signal demodulated by the physical channel signal demodulation unit 1041 is a signal transmitted by the STA 2 and the STA 3 on the uplink, and its frame configuration is the same as that of the data frame generated by the frame configuration unit 1032. Therefore, the physical channel signal demodulation unit 1041 can demodulate the uplink data from the data channel based on the control information transmitted on the control channel of the data frame. In addition, the physical channel signal demodulation unit 1041 may include a carrier sense function.

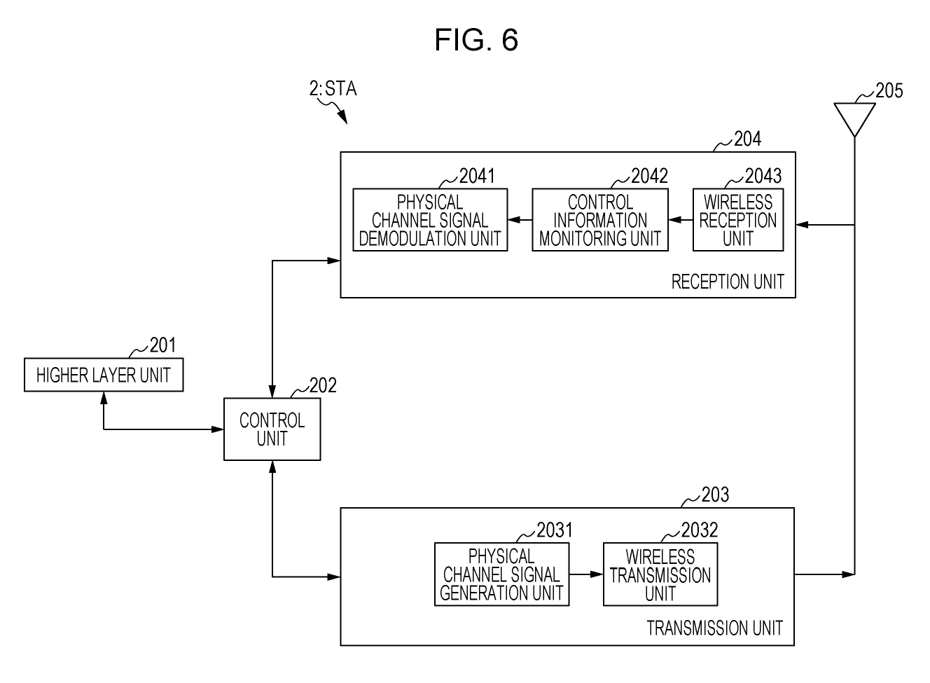

FIG. 6 is a block diagram illustrating a configuration example of the STA 2 according to the present embodiment. As illustrated in FIG. 6, the STA 2 includes a higher layer unit 201, a control unit 202, a transmission unit 203, a reception unit 204, and an antenna 205.

The higher layer unit 201 performs processes of the MAC layer or the like. In addition, the higher layer unit 201 generates information for controlling the transmission unit 203 and the reception unit 204, and outputs the information to the control unit 202.

The antenna 205 receives the signal transmitted by the AP 1 and outputs it to the reception unit 204.

The reception unit 204 includes a physical channel signal demodulation unit 2041, a control information monitoring unit 2042, and a wireless reception unit 2043. The wireless reception unit 2043 converts the RF band signal input from the antenna 205 into a baseband signal. The process performed by the wireless reception unit 2043 includes frequency conversion from the RF band to the baseband band, filtering, analog/digital conversion, and the like.

The control information monitoring unit 2042 reads information described in the PHY header (for example, L-SIG or VHT-SIG-A) of the transmission frame transmitted by the AP 1 from the baseband signal output by the wireless reception unit 2043, and inputs it to the physical channel signal demodulation unit 2041.

The physical channel signal demodulation unit 2041 demodulates the transmission frame transmitted by the AP 1, based on the control information acquired by the control information monitoring unit 2042 and inputs the demodulation result to the higher layer unit 201 through the control unit 202.

The higher layer unit 201 interprets the data demodulated by the physical channel signal demodulation unit 2041 in the MAC layer, the logical link control (LLC) layer, and the transport layer, respectively. As the process in the MAC layer by the higher layer unit 201, information on the CCA level can be acquired from the transmission frame transmitted by the AP 1. For example, when the higher layer unit 201 interprets that the transmission frame transmitted by the AP 1 is a beacon frame, it is possible to acquire the CCA level described in the CCA field of the beacon frame. The acquired CCA level is input to the reception unit 2043 through the control unit 202.

In addition, the process performed by the reception unit 204 may include a function of measuring (carrier sense) ambient interference in a specific frequency band and securing the frequency band.

The STA 2 also has a function of transmitting a signal. The antenna 205 transmits the signal of the RF band generated by the transmission unit 203 to the AP 1.

The transmission unit 203 includes a physical channel signal generation unit 2031 and a wireless transmission unit 2032. The physical channel signal generation unit 2031 generates a baseband signal that the STA 2 transmits to the AP 1. The signal generated by the physical channel signal generation unit 2031 has the same configuration as the transmission frame generated by the frame configuration unit 1032 of the AP 1.

The wireless transmission unit 2032 converts the baseband band signal generated by the physical channel signal generation unit 2031 into a signal in the RF band. The process performed by the wireless transmission unit 2032 includes digital-analog conversion, filtering, frequency conversion from a baseband to an RF band, and the like.

Here, since the STA 2 is connected to the AP 1 based on the CSMA/CA, the reception unit 204 performs the carrier sense prior to the transmission process of the transmission unit 203. When the reception unit 204 determines that it is possible to ensure the frequency band from a result of the carrier sense for a certain frequency band, the transmission unit 203 can start a transmission process.

The reception unit 204 can perform carrier sense based on the CCA level notified from the higher layer unit 201. For example, when the power of the signal received by the wireless reception unit 2043 of the reception unit 204 is larger than the CCA level, the reception unit 204 determines that the frequency band cannot be ensured. For example, when the power of the signal received by the wireless reception unit 2043 of the reception unit 204 is smaller than the CCA level, the reception unit 204 can determine that the frequency band can be ensured. Therefore, the higher the CCA level used by the reception unit 204 is, the greater the communication opportunity of the STA 2 is.

On the other hand, when the number of STAs 2 provided in the communication system is large and the CCA level used by each STA 2 is high, a lot of interference is included in the signals received by each STA 2, such that the reception quality of the transmission frame transmitted by the STA 2 deteriorates. Therefore, the physical channel signal generation units 1031 and 2031 of the AP 1 and the STA 2 can use a data modulation scheme with a low modulation level or an error correction code with a low coding rate in anticipation of loss of reception quality in advance.

Further, the reception unit 204 may change the CCA level depending on the type (kind) of the received signal. For example, carrier sense can be performed at the CCA level notified from the AP 1, only when it is determined that the signal received by the reception unit 204 is a transmission frame transmitted from another STA 2 to which the present invention is applied. On the other hand, when the received signal is determined to be a transmission frame transmitted from another STA 3 that is a legacy terminal device, the reception unit 204 can perform carrier sense at the legacy CCA level.

Further, the reception unit 204 may change the CCA level depending on the frequency (histogram) of the received signal. For example, when most of the signals received by the reception unit 204 during a certain period is a transmission frame transmitted from another STA 2 to which the present invention is applied, the reception unit 204 can perform carrier sense at the CCA level notified from the AP 1. On the other hand, when most of the signals received by the reception unit 204 during a certain period is a transmission frame transmitted from the STA 3 to which the present invention is not applied, the reception unit 204 can perform carrier sense at the legacy CCA level. In addition, information on the histogram described above can be signaled from the AP1 to the STA 2.

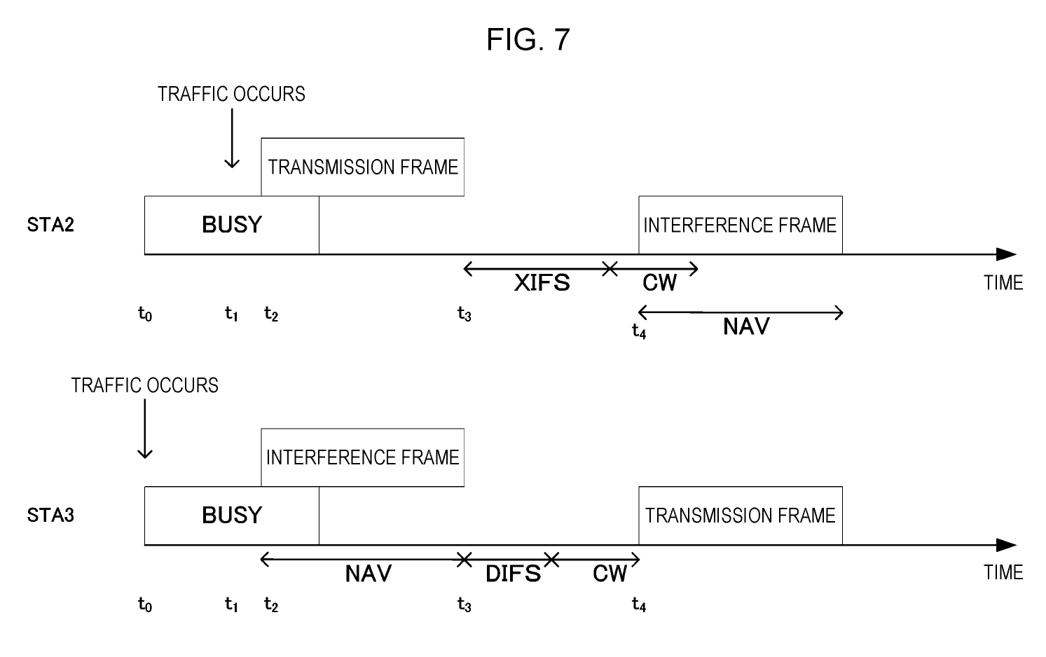

FIG. 7 is a diagram illustrating the flow of communication according to this embodiment. First, at time to, it is assumed that some interference occurs in the BSS. However, it is assumed that the power of the interference is lower than the CCA level notified to the STA 2 in the CCA field of the beacon frame by the AP 1, but higher than the legacy CCA level used by the STA 3.

At time t₀, transmission traffic occurs in the STA 3, but the STA 3 cannot obtain communication opportunities because it observes interference of the legacy CCA level or more by carrier sense. On the other hand, since traffic occurs at time t₁ in the STA 2, and the reception unit 204 of STA 2 can determine that there is no interference of the CCA level or more by carrier sense, the STA 2 can obtain communication opportunities, and actually transmit a transmission frame at time t₂ after a standby time such as a random backoff time described later.

Since the STA 3 can recognize a period (t₂ to t₃) required by the STA 2 for transmission, from the information on the frame length written in the PHY header of the transmission frame transmitted from the STA 2 at the time t₂, the STA 3 sets the period as a network allocation vector (NAV) period, and do not attempt to start transmission during that period.

After the transmission by the STA 2 is completed (time t₃), the STA 2 and the STA 3 waits only for an IFS period which is a frame transmission standby time giving a priority to a transmission frame, and a CW period which is a random backoff time to avoid packet collision. The communication opportunities are given to the STA 2 or the STA 3 having the shortest period. Here, if the STA 2 uses the same frame transmission standby time as that of the STA 3, the STA 2 can perform carrier sense using the CCA level notified from the AP 1, so that if the CCA level usable by the STA 2 is higher than the legacy CCA level used by the STA 3 which is the legacy terminal, the communication opportunity of the STA 3 is significantly lower than the communication opportunity of that of the STA 2.

Therefore, when performing carrier sense using the CCA level notified from the AP 1, the STA 2 according to the present embodiment acquires a communication opportunity using a frame transmission standby time longer than that of the existing STA 3. For example, in the case of STA 3, if the STA 2 transmits a transmission frame of a frame type of perform transmission using the DIFS, the STA 2 may acquire a communication opportunity by using an IFS (described as XIFS in FIG. 7) longer than the DIFS. By controlling in this manner, it is possible to avoid unfairness in communication opportunities between the STA 2 and the STA 3.

In the communication system targeted by the present embodiment, XIFS is not particularly limited. The STA 2 can perform communication by using a certain value of XIFS instead of the DIFS. Further, the AP 1 and the STA 2 may determine the value of XIFS, based on the CCA notified by the AP 1 in the CCA field. For example, the STA 2 may use a period obtained by adding the period (IFS offset) determined based on the CCA level to the DIFS, as the XIFS.

In addition, the STA 2 may not use XIFS for all transmissions of the STA 2 itself. For example, in a case of the STA 3 which is a legacy terminal device, the STA 2 performs communication using XIFS only when transmitting a transmission frame of a frame type of using the DIFS or an arbitration inter frame space (AIFS), and the STA 2 can use SIFS as in the legacy terminal device, when transmitting a transmission frame of a frame type in which the STA 3 uses SIFS.

Furthermore, in the communication system targeted by the present embodiment, a plurality of IFSs can be prepared to give priorities to transmission frames. For example, in the communication system targeted by the present embodiment, it is possible to newly define the IFS to be used when performing communication based on the CCA level different from the legacy CCA level, as XIFS. In this case, when the communication opportunity is obtained by carrier sense with the CCA level higher than the legacy CCA level, the STA 2 may use XIFS as the frame transmission standby time. On the other hand, when the STA 2 obtains communication opportunities by carrier sense based on the legacy CCA level, the existing IFS may be used as the frame transmission standby time.

In addition, similarly to the CCA level, the AP 1 can signal information on the XIFS (the period itself of the XIFS or the value of the IFS offset) to the STA 2, using a management frame such as a beacon frame or the PHY header of a transmission frame.

Further, the communication system targeted by the present embodiment can define a new CCA level lower than the legacy CCA level. In this case, for example, when the STA 2 transmits a transmission frame of a frame type of performing transmission using DIFS in the case of the STA 3 that is a legacy terminal device, the STA 2 can always perform communication using the XIFS shorter than the DIFS.

According to the AP 1 and the STA 2 described above, a communication system is possible which is capable of securing communication opportunities of the existing STAs 3 while the AP 1 and the STA 2 perform communication based on the CCA level higher than the existing STA 3, it is possible to greatly improve the system throughput of the communication system.

### 2. Second Embodiment

In the present embodiment, the STA, that can change the CCA level used for carrier sense in response to an instruction from the AP or the like, changes a random backoff time included in the transmission standby time, according to the CCA level.

Since the outline of the communication system targeted by the present embodiment and the configurations of the AP 1 and the STA 2 are the same as those in Embodiment 1, the description thereof will be omitted. This embodiment is different from the first embodiment in the signal process about transmission start of the STA 2.

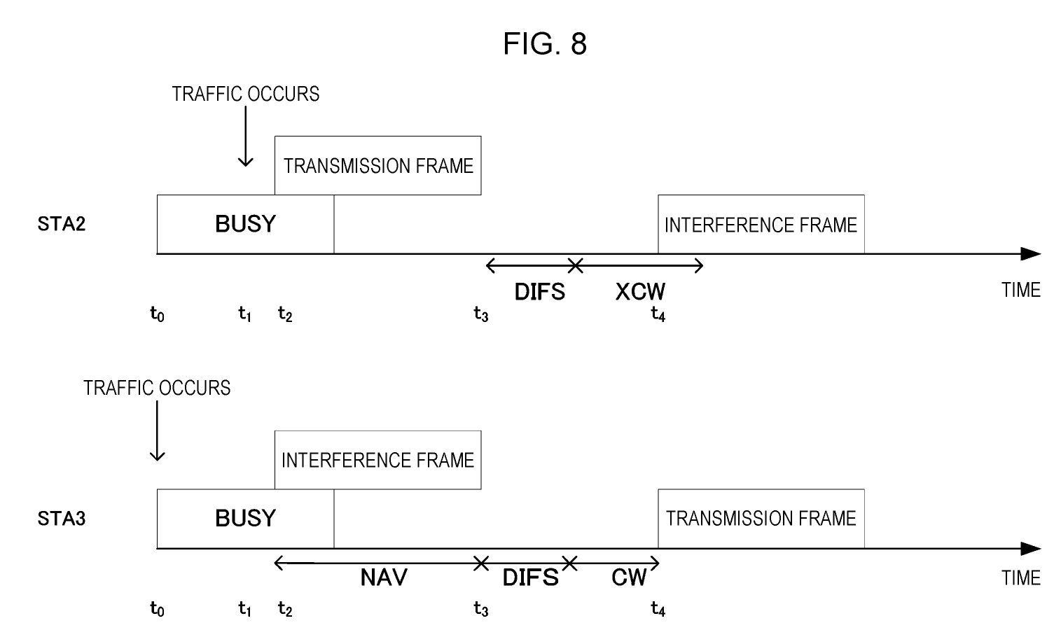

FIG. 8 is a diagram illustrating the flow of communication according to this embodiment. As in FIG. 7, first, at time t₀, it is assumed that some interference occurs in the BSS. However, it is assumed that the power of the interference is lower than the CCA level notified to the STA 2 in the CCA field of the beacon frame by the AP 1, but higher than the legacy CCA level used by the STA 3.

Since the situation in the BSS up to the time t₃ and the signal process of the STA 2 and the STA 3 are the same as those in FIG. 7, the description thereof will be omitted. Since the transmission of the transmission frame of the STA 2 is completed at the time t₃, the STA 2 and the STA 3 waits only for IFS which is the frame transmission standby time and CW which is the random backoff time to avoid packet collision. In the first embodiment, in order to ensure communication opportunities of the STA 3 which is a legacy terminal using the legacy CCA level, the STA 2 uses IFS having a longer period than the IFS used by the STA 3.

The STA 2 according to the present embodiment uses the same IFS (DIFS in FIG. 8) as that of the STA 3 which is a legacy terminal device. The STA 2 ensures the communication opportunity of the STA 3, by using CW (denoted as XCW in FIG. 8) different from in the STA 3. Since the STA2 and the STA3 use the same IFS, the STA 2 and the STA 3 can equalize priorities according to the types of transmission frames.

The CW is used to prevent collision of packet transmission between STAs. For example, each STA acquires a prescribed numerical value (CWmax) based on the transmission scheme used for communication with the AP 1 and the broadcast information from the AP 1 (for example, information transmitted in a beacon frame). Each STA randomly selects one numerical value (CW counter) between 1 and CWmax. Each STA waits for transmission only for a period (for example, CW counter x microsecond) determined based on the CW counter, thereby reducing the possibility of collision of transmission frames with other STAs. If there is a STA with a large CWmax, the communication opportunity for the STA will decrease, relative to other STAs.

Therefore, the STA 2 according to the present embodiment can change CWmax according to the CCA level used by the reception unit 204. Although a method of changing CWmax is not particularly limited, the STA 2 can use CW, with CWmax as a value obtained by adding a value determined based on the CCA level to CWmax used by the STA 3 which is a legacy terminal device. For example, if the CCA level of the STA 2 is higher than the legacy CCA level only by XdBm, the STA 2 can use CWmax+X as CWmax, with respect to CWmax used by the STA 3.

The STA 2 can recognize a method of calculating CWmax in advance. Further, the AP 1 may signal the information on the value of CWmax to the STA 2, by using the data of the MAC layer and the PHY header of the transmission frame.

According to the AP 1 and the STA 2 described above, a system can be obtained in which the AP 1 and the STA 2 perform communication based on the CCA level higher than the existing STA 3, and the communication system is capable of securing communication opportunities of the existing STA 3, such that it is possible to greatly improve the system throughput of the communication system.

### 3. Common Things to All Embodiments

Programs operating on the AP 1, the STA 2 and the STA 3 according to the present invention are programs for controlling the CPU and the like so as to realize the functions of the above embodiments according to the present invention (programs for causing a computer to function). Information handled by these devices is temporarily stored in the RAM at the time of processing, and thereafter is stored in various ROMs and HDDs, and is read, modified and written by the CPU as needed. Examples of the recording medium for storing the program include a semiconductor medium (for example, a ROM, a non-volatile memory card, or the like), an optical recording medium (for example, a DVD, an MO, an MD, a CD, a BD, or the like), and a magnetic recording medium (for example, a flexible disk, or the like). Further, the functions of the above-described embodiments are realized by executing the loaded program, and the functions of the invention may be realized by processing in cooperation with the operating system or another application program or the like based on the instruction of the program, in some cases.

In the case of distribution to the market, it is possible to store and distribute the program in a portable recording medium, or transfer the program to a server computer connected through a network such as the Internet. In this case, the storage device of the server computer is also included in the present invention. In addition, some or all of the AP 1, the STA 2 and the STA 3 according to the above-described embodiments may be realized as an LSI which is a typical integrated circuit. The functional blocks of the AP 1, the STA 2 and the STA 3 may be individually formed into chips, or some or all of them may be integrated into chips. When respective functional block are integrated, an integrated circuit control unit for controlling them is added.

In addition, a method of forming an integrated circuit is not limited to LSI, and it may be realized by a dedicated circuit or a general-purpose processor. In addition, when advances in semiconductor technology have led to the development of integrated circuit technology to replace LSI, it is also possible to use an integrated circuit according to the technology.

The present invention is not limited to the above-described embodiment. The AP 1, the STA 2, and the STA 3 of the present invention are not limited to application to a mobile station apparatus but can be applied to stationary or non-movable type electronic equipment installed indoors or outdoors, and it goes without saying that it can be applied to, for example, AV equipment, kitchen equipment, cleaning and laundry equipment, air conditioner, office equipment, vending machine, other living equipment, and the like.

Although the embodiment of the present invention has been described above in detail with reference to the drawings, the specific configuration is not limited to this embodiment, and designs and the like within the scope without departing from the gist of the present invention are included in the scope of the claims.

### INDUSTRIAL APPLICABILITY

It is preferable that the present invention is applied to a radio transmission device, a radio reception device, a communication system, and a communication method.

Note that this international application claims priority based on Japanese Patent Application No. 2014-185781 filed on Sep. 12, 2014, and all the contents of Japanese Patent Application No. 2014-185781 are incorporated into this international application.

### REFERENCE SIGNS LIST

1 AP
2, 2-1, 2-2, 2-3, 2-4, 3, 3-1, 3-2, 3-3, 3-4 STA
101, 201 Higher Layer Unit
102, 202 Control Unit
103, 203 Transmission Unit
104, 204 Reception Unit
105, 205 Antenna
1031, 2031 Physical Channel Signal Generation Unit
1032 Frame Configuration Unit
1033 Control Signal Generation Unit
1034, 2032 Wireless Transmission Unit
1041, 2041 Physical Channel Signal Demodulation Unit
1042, 2043 Wireless Reception Unit
2042 Control Information Monitoring Unit

1: A radio reception device which performs communication with a radio transmission device, comprising:
wireless reception circuitry is configured to perform the carrier sense; and
wireless transmission circuitry is configured to transmit a frame addressed to the radio transmission device,
wherein the wireless reception circuitry is configured to
receive a signal of information on a CCA level used for the carrier sense from the radio transmission device, and
determine the CCA level used for the carrier sense based on the signal, and
wherein a period during which the carrier sense is performed is different in a case where the CCA level is changed and in a case where the CCA level is not changed.

2: The radio reception device according to claim 1,
wherein the wireless reception circuitry is configured to change the CCA level, based on a type of a received signal.

3. (canceled)

4: The radio reception device according to claim 1,
wherein the period during which the carrier sense is performed includes a frame transmission standby time,
wherein the wireless transmission circuitry has a plurality of the frame transmission standby times,
wherein at least one of the plurality of frame transmission standby times is determined based on the CCA level, and
wherein the frame transmission standby times are included in the transmission standby time.

5: The radio reception device according to claim 4,
wherein the wireless transmission circuitry is configured to switch the frame transmission standby times, depending on the CCA level used by the wireless reception circuitry for the carrier sense.

6: The radio reception device according to claim 1,
wherein the period during which the carrier sense is performed includes a random backoff time,
wherein the wireless transmission circuitry has a function of determining the random backoff time,
wherein the random backoff time is determined based on the CCA level, and
wherein the random backoff time is included in the transmission standby time.

7: The radio reception device according to claim 4,
wherein the wireless transmission circuitry is configured to determine the frame transmission standby time, based on a type of a signal addressed to the radio transmission device.

8: A radio transmission device which performs communication with a radio reception device, comprising:
wireless reception circuitry configured to perform carrier sense; and
wireless transmission circuitry configured to transmit a beacon frame in which information on a CCA level used for the carrier sense performed by the radio reception device is described.

9: The radio transmission device according to claim 8,
wherein the information on the CCA level is a difference from a legacy CCA level.

10-13. (canceled)

14: The radio transmission device according to claim 8,
wherein the wireless transmission circuitry is configured to transmit a frame addressed to the radio reception device, and
wherein a PHY header included in the frame includes the information on the CCA level.

15: A communication method of a radio reception device which performs communication with a radio transmission device, comprising:
a step of performing carrier sense;
a step of transmitting a frame addressed to the radio transmission device;
a step of receiving a signal of information on a CCA level used for the carrier sense from the radio transmission device; and
a step of determining the CCA level used for the carrier sense based on the signal,
wherein a period during which the carrier sense is performed is different in a case where the CCA level is changed and in a case where the CCA level is not changed.
